(19) United States
(12) Patent Application Publication
(10) Pub. No.: US 2011/0024686 A1
(43) Pub. Date: Feb. 3, 2011

(54) Composition and Process for Preparing Phosphorescent Masterbatch and Phosphorescent Article Containing the Same

(75) Inventors: Hsi-Wen Chang, Jhonghe City (TW); Sheng-Jen Lin, Taoyuan City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: TAIWAN TEXTILE RESEARCH INSTITUTE, Tu-Chen City (TW)

(21) Appl. No.: 12/512,471

(22) Filed: Jul. 30, 2009

(51) Int. Cl. C09K 11/80; C09K 11/56

(52) U.S. Cl. 252/301.36

(57) ABSTRACT

A composition for preparing a phosphorescent masterbatch is provided. The composition includes about 1-45 wt % of a phosphorescent material, about 0.1-10 wt % of a crosslinking, about 38-98.8 wt % of a thermoplastic polymer, about 0-0.2 wt % of a crosslinking initiator, and about 0.1-5 wt % of a dispersing agent.

### BACKGROUND

1. Field of Invention

The present invention relates to a phosphorescent masterbatch. More particularly, the present invention relates to compositions and process for preparing the phosphorescent masterbatch.

2. Description of Related Art

The use of phosphorescent materials in the production of luminescent articles is very well known. Phosphorescent phosphors are substances that emit light after absorbing ultraviolet radiation or the like, and the afterglow of the light that can be visually observed continues for a time (known as afterglow time) after the removal of the source of the stimulus.

In some applications, for example, phosphorescent materials are coated, printed or otherwise formed on the surface of an article to provide the article with luminescent ability. In some other applications, phosphorescent materials are incorporated into thermoplastic polymers which will later be processed to produce luminescent articles.

In the latter case, polymer compositions containing phosphorescent materials are usually prepared in the form of masterbatches. Generally, a masterbatch is a granular, usually dust-free concentrate of a polymer that may or may not contain a modifying agent capable of altering/modifying physical and/or chemical properties of the polymer.

Unfortunately, in the conventional phosphorescent masterbatches, relatively large amount of phosphorescent materials are needed to maximize the afterglow light intensity of the phosphorescent masterbatches and the luminescent articles manufactured therefrom. However, the mechanical strength of the polymer would decrease as the amount of phosphorescent material therein increases. Also, in the textile application, masterbatches containing high concentration of phosphorescent materials may render the spinning and/or processing steps difficult.

In view of the foregoing, there is a need in the related art to provide a phosphorescent masterbatch having reduced amount of phosphorescent materials yet exhibiting adequate afterglow characteristics.

### SUMMARY

The following presents a simplified summary of the disclosure in order to provide a basic understanding to the reader. This summary is not an extensive overview of the disclosure and it does not identify key/critical elements of the present invention or delineate the scope of the present invention. Its sole purpose is to present some concepts disclosed herein in a simplified form as a prelude to the more detailed description that is presented later.

In one aspect, the present invention is directed to a composition for preparing a phosphorescent masterbatch.

According to one embodiment of the present invention, the composition for preparing a phosphorescent masterbatch comprises about 3.0 to 45.0 wt % of a phosphorescent material, about 0.1 to 10.0 wt % of a crosslinking agent, about 38.0 to 96.8 wt % of a thermoplastic polymer, about 0 to 0.2 wt % of a crosslinking initiator, and about 0.1 to 5.0 wt % of a dispersing agent.

In another aspect, the present invention is directed to a process for preparing a phosphorescent masterbatch.

According to one embodiment of the present invention, the process comprises steps as follows. The composition according to the above-mentioned aspect of the present invention is provided. The composition is compounded to melt the thermoplastic polymer whereby the melted thermoplastic polymer is cross-linked by the crosslinking agent, and the phosphorescent material is dispersed in the cross-linked thermoplastic. The cross-linked thermoplastic having the phosphorescent material dispersed therein is pelletized to obtain the phosphorescent masterbatch.

In still another aspect, the present invention is directed to a phosphorescent masterbatch.

According to one embodiment of the present invention, the phosphorescent masterbatch comprises a thermoplastic polymer cross-linked by a crosslinking agent and a phosphorescent material dispersed in the cross-linked thermoplastic polymer. A weight percent of the phosphorescent material to the phosphorescent masterbatch is about 3.0 to 45.0, while a weight percent of the crosslinking agent to the phosphorescent masterbatch is about 0.1 to 10.0.

In yet another aspect, the present invention is directed to a luminescent article.

According to one embodiment of the present invention, the article of manufacture comprises a luminescent portion that is at least made of the phosphorescent masterbatch according to the above-mentioned aspect of the present invention.

Many of the attendant features will be more readily appreciated as the same becomes better understood by reference to the following detailed description considered in connection with the accompanying drawings.

### DETAILED DESCRIPTION

The detailed description provided below is intended as an illustrative description of the present embodiments and is not intended to represent the only forms in which the present embodiments may be constructed or utilized. The description sets forth the functions of the embodiments and the sequence of steps for constructing and operating the embodiments. However, the same or equivalent functions and sequences may be accomplished by different embodiments.

Embodiments and examples regarding the compositions and processes for preparing phosphorescent masterbatches and luminescent articles manufactured therefrom are provided hereinafter. The phosphorescent masterbatches and luminescent articles thus prepared, as compared with conventional ones, contain lesser amount of phosphorescent materials yet exhibit comparable or even superior afterglow characteristics such as light intensity and/or afterglow time.

### (I) Compositions and Processes for Preparing Phosphorescent Masterbatches

According to the principles and spirits of the present invention, composition for preparing a phosphorescent masterbatch is provided, mixed well, compounded, and pelletized to yield a phosphorescent masterbatch.

Generally, the composition for preparing a phosphorescent masterbatch comprises a phosphorescent material, a crosslinking agent, a thermoplastic polymer, a crosslinking initiator, and a dispersing agent. Examples and proportions of the aforementioned constituents are provided hereinafter.

Any suitable phosphorescent materials may be used according to embodiments of the present invention. Illustrative examples of the phosphorescent materials include rare-earth-doped aluminates and metal sulfides. Specifically, the rare-earth-doped aluminates may have a formula of (MAl₂O₄:Eu,Re), where M is Mg, Ca, Sr, or Ba, and Re is Y, La, Ce, Pr, Nd, Sm, Gd, Tb, Dy, Ho, Er, Tm, Yb or Lu. Illustrative examples of metal sulfides include, but are not limited to, zinc sulfide, cadmium sulfide, calcium sulfide, and strontium sulfide.

In some embodiments of the present invention, the rare-earth-doped aluminate having the formula of SrAl₂O₄:Eu,Dy is used as the phosphorescent material.

According to various embodiments of the present invention, the weight percent of the phosphorescent material of the composition for preparing a phosphorescent masterbatch is about 3.0 to 45.0. In some embodiments, the phosphorescent material comprises about 10.0 to 15.0% by weight of the total composition. In some other embodiments, the phosphorescent material comprises about 5.0 to 7.0% by weight of the total composition.

Specifically, the weight percent of the phosphorescent material of the total composition may be about 3.0, 3.5, 4.0, 5.0, 5.5, 6.0, 6.5, 7.0, 7.5, 8.0, 8.5, 9.0, 9.5, 10.0, 11.0, 12.0, 13.0, 14.0, 15.0, 16.0, 17.0, 18.0, 19.0, 20.0, 21.0, 22.0, 23.0, 24.0, 25.0, 26.0, 27.0, 28.0, 29.0, 30.0, 31.0, 32.0, 33.0, 34.0, 35.0, 36.0, 37.0, 38.0, 39.0, 40.0, 41.0, 42.0, 43.0, 44.0, and 45.0.

According to one embodiment of the present invention, the crosslinking agent is triacryloylhexahydro-1,3,5-triazine (TAT). Alternatively, the crosslinking agent may be a diallyl compound or a triallyl compound according to other embodiments of the present invention. Illustrative examples of diallyl compounds include, but are not limited to, diallyl phthalate (DAP), diallyl succinate (DASu), and N,N′-diallyltartramide (DATD). Illustrative examples of triallyl compounds include, but are not limited to, triallylamine, triallyl trimesate (TAM), triallyl cyanurate (TAC), triallyl isocynaurate (TAIC), and triallyl-ammoniumcyanurate.

According to various embodiments of the present invention, the weight percent of the crosslinking agent of the composition for preparing a phosphorescent masterbatch is about 0.1 to 10.0. In some embodiments, the crosslinking agent comprises about 0.1 to 5.0% by weight of the total composition. Specifically, the weight percent of the crosslinking agent of the total composition may be about 0.1, 0.2, 0.3, 0.4, 0.5, 0.6, 0.7, 0.8, 0.9, 1.0, 1.5, 2.0, 2.5, 3.0, 3.5, 4.0, 4.5, 5.0, 5.5, 6.0, 6.5, 7.0, 7.5, 8.0, 8.5, 9.0, 9.5, and 10.0.

According to embodiments of the present invention, the crosslinking initiator is an optional constituent of the composition because the crosslinking agent may still initialize the crosslinking reaction in the absence of the crosslinking initiator. However, the addition of the crosslinking initiator in the composition may facilitate the crosslinking reaction. Hence, the weight percent of the crosslinking agent of the composition for preparing a phosphorescent masterbatch is about 0 to 2.0; more specifically, about 0.1, 0.2, 0.3, 0.4, 0.5, 1.0, 1.5, and 2.

The choice of the crosslinking initiator often depends on the crosslinking agent to be used. Illustrative examples of crosslinking initiators include, but are not limited to, potassium persulfate, azobisisobutyronitrile, and benzyl dimethyl ketal (BDK).

The dispersing agent may assist in uniform distribution of the constituents within the composition. Generally, the dispersing agent may be C₁₅₋₃₈ alkanes, C₁₅₋₃₈ esters, C₁₅₋₃₈ organic acids, and mixtures thereof.

According to various embodiments of the present invention, the weight percent of the dispersing agent of the composition for preparing a phosphorescent masterbatch is about 0.1 to 5.0. Specifically, the weight percent of the dispersing agent of the total composition may be about 0.1, 0.2, 0.3, 0.4, 0.5, 0.6, 0.7, 0.8, 0.9, 1.0, 1.5, 2.0, 2.5, 3.0, 3.5, 4.0, 4.5, and 5.0.

Any synthetic thermoplastic polymer may be used according to the embodiments of the present invention, includes, but is not limited to, polyester, polyamide, and polypropylene (PP). Specifically, illustrative examples of polyester include polyethylene terephthalate (PET), polybutylene terephthalate (PBT), and polytrimethylene terephthalate (PTT). Polyamide is a synthetic polymer family including nylon 6, nylon 11, nylon 12, nylon 46 or nylon 66.

The weight percent of the thermoplastic polymer of the total composition is about 38.0 to 96.8. In some embodiments, the thermoplastic polymer is polyamide and comprises about 74.0 to 96.8% by weight of the total composition. In some other embodiments, the thermoplastic polymer is PBT and comprises about 81.3 to 88.9% by weight of the total composition.

Specifically, the weight percent of the thermoplastic polymer of the total composition may be about 38.0, 38.5, 39.0, 39.5, 40.0, 40.5, 41.0, 42.0, 43.0, 44.0, 45.0, 46.0, 47.0, 48.0, 49.0, 50.0, 52.0, 54.0, 56.0, 58.0, 60.0, 62.0, 64.0, 66.0, 68.0, 70.0, 72.0, 74.0, 76.0, 78.0, 80.0, 81.3, 82.0, 84.0, 86.0, 88.0, 88.9, 90.0, 91.8, 92.0, 93.0, 94.0, 95, 96, and 96.8.

Now that various compositions for preparing the phosphorescent masterbatch according to the present invention are disclosed, the process steps for preparing the phosphorescent masterbatch are set forth hereinafter in conjunction with some experimental examples.

Generally, a composition for preparing the phosphorescent masterbatch is prepared according to the embodiments of the present invention. The composition is compounded and then pelletized.

Specifically, the composition is prepared by combining about 3.0 to 45.0 percent by weight of a phosphorescent material, about 0.1 to 10.0 percent by weight of a crosslinking agent, about 38.0 to 96.8 percent by weight of a thermoplastic polymer, about 0 to 2.0 percent by weight of a crosslinking initiator, and about 0.1 to 5.0 percent by weight of a dispersing agent. Various compositions may be prepared according to the above-described embodiments and combinations thereof.

In some embodiments, the combining step may be carried out in any suitable container or mixer. Thereafter, the composition is fed into an extruder for forming the phosphorescent masterbatch. Alternatively, the combining step may be done in the extruder.

The compounding and pelletizing steps are carried out in the extruder. Any customary extruders and extrusion techniques for preparing masterbatches may be employed according to the embodiments of the present invention.

In the compounding step, the thermoplastic polymer of the composition is melted by heat, and the remaining constituents of the composition and the melted thermoplastic polymer are mixed well. According to the process of various embodiments of the present invention, the melted thermoplastic polymer is cross-linked under the action of the crosslinking agent, and the phosphorescent material is dispersed in the cross-linked thermoplastic polymer with the help of the dispersing agent and the mixing action provided by the extruder. As such, the phosphorescent material may be evenly dispersed in the cross-linked thermoplastic polymer.

In the pelletizing step, the cross-linked thermoplastic polymer having the phosphorescent material dispersed therein is pelletized to obtain the phosphorescent masterbatch according to one aspect of the present invention.

Some experimental examples according to embodiments of the present invention are provided. In the following examples, rare-earth-doped aluminate having the formula of (SrAl₂O₄:Eu,Dy), benzyl dimethyl ketal (BDK), and a mixture containing the above-named C₁₅₋₃₈ compounds were respectively used as the phosphorescent material, crosslinking initiator, and dispersing agent. Detailed compositions of each example are listed in Table.

TABLE 1

| | Thermoplastic | Cross-linking agent | SrAl₂O₄:Eu,Dy | | C₁₅₋₃₈ |
|---|---|---|---|---|---|
| No. | polymer (wt %) | (wt %) | (wt %) | BDK (wt %) | (wt %) |
| | PBT | TAT | | | |
| A1 | 72.9 | 0.1 | 25 | 0.5 | 1.5 |
| A2 | 72.5 | 0.5 | 25 | 0.5 | 1.5 |
| A3 | 72.0 | 1.0 | 25 | 0.5 | 1.5 |
| A4 | 71.5 | 1.5 | 25 | 0.5 | 1.5 |
| A5 | 71.0 | 2.0 | 25 | 0.5 | 1.5 |
| A6 | 63.0 | 10.0 | 25 | 0.5 | 1.5 |
| A7 | 92.0 | 1.0 | 5 | 0.5 | 1.5 |
| A8 | 87.0 | 1.0 | 10 | 0.5 | 1.5 |
| A9 | 82.0 | 1.0 | 15 | 0.5 | 1.5 |
| A10 | 77.0 | 1.0 | 20 | 0.5 | 1.5 |
| A11 | 43.0 | 10.0 | 45 | 0.5 | 1.5 |
| | | triallyl- | | | |
| | PBT | ammoniumcyanurate | | | |
| B1 | 72.5 | 0.5 | 25.0 | 0.5 | 1.5 |
| B2 | 72.0 | 1.0 | 25.0 | 0.5 | 1.5 |
| B3 | 71.5 | 1.5 | 25.0 | 0.5 | 1.5 |
| B4 | 71.0 | 2.0 | 25.0 | 0.5 | 1.5 |
| | Polyamide | | | | |
| | (Nylon6) | TAT | | | |
| C1 | 90.0 | 1.0 | 7.0 | 0.5 | 1.5 |
| C2 | 87.0 | 1.0 | 10.0 | 0.5 | 1.5 |
| C3 | 94.0 | 1.0 | 3.0 | 0.5 | 1.5 |
| C4 | 56.5 | 1.5 | 40.0 | 0.5 | 1.5 |

Take example C1 for example, the composition was prepared by combining about 90.0 wt % of polyamide, about 1.0 wt % of triallyl-ammoniumcyanurate, about 7.0 wt % of SrAl₂O₄:Eu,Dy, about 1.5 wt % of a dispersing mixture, and about 0.5 wt % of benzyl dimethyl ketal.

Each of the compositions of examples A1-A11 and B1-B4 was compounded in a twin screw extruder at a temperature of about 230 to 275° C., and the compounding step lasted for about 1 to 10 minutes. Each of the compositions of examples C1-C4 was compounded in a twin screw extruder at a temperature of about 230 to 265° C., and the compounding step lasted for about 1 to 10 minutes.

After the compounding step, each of the compounded compositions was pelletized to produce respective phosphorescent masterbatch of the pertinent example.

### (II) Phosphorescent Masterbatches and Their Afterglow Characteristics

In another aspect, the present invention is directed to a phosphorescent masterbatch prepared from the composition and process according to the above-described embodiments of the present invention.

The phosphorescent masterbatch comprises a thermoplastic polymer cross-linked by a crosslinking agent and a phosphorescent material dispersed in the cross-linked thermoplastic polymer. According to various embodiments of the present invention, the weight percent of the phosphorescent material to the phosphorescent masterbatch is about 3.0 to 45.0, while the weight percent of the crosslinking agent to the phosphorescent masterbatch is about 0.1 to 10.0.

Since the phosphorescent masterbatch is produced from the composition of the present invention, the species and proportions of the constituents of the composition are covered by the embodiments described-above and their equivalents; hence are not illustrated here for the sake of brevity.

The phosphorescent masterbatches prepared according to the experimental examples are tested for the light intensity of the afterglow. The sample was illuminated by CIE (International Commission on Illumination) standard illuminant D65 for about 20 minutes. Afterwards, the sample was put in a dark room to allow the sample to glow. The light intensity emitted by each sample was measured every 2 minute for the following 120 minutes. The average of the measurements during the period is listed in Table 2.

TABLE 2

| | Light Intensity |
|---|---|
| No. | (mcd/m²) |
| A1 | 657 |
| A2 | 982 |
| A3 | 1128 |
| A4 | 1181 |
| A5 | 1080 |
| A6 | 1206 |
| A7 | 515 |
| A8 | 829 |
| A9 | 1150 |
| A10 | 1290 |
| A11 | 1310 |
| B1 | 928 |
| B2 | 1050 |
| B3 | 1128 |
| B4 | 1160 |
| C1 | 657 |
| C2 | 684 |
| C3 | 257 |
| C4 | 970 |
| Control 1* | 632 |
| Control 2* | 156 |
| Control 3* | 1177 |

*Composition for Control 1: 25 wt % of SrAl₂O₄:Eu,Dy and 1.5 wt % of dispersing agent @ PBT; composition for Control 2: 15 wt % of SrAl₂O₄:Eu,Dy and 1.5 wt % of dispersing agent @ Polyamide; and Control 3: 100 wt % of SrAl₂O₄:Eu,Dy powder.

As can be seen in Table 2, control 1 comprises about 25 wt % of the phosphorescent material, and the light intensity of the afterglow thereof is about 632 mcd/m². On the other hand, each of the examples A1 to A6 comprises the same level of the phosphorescent material as the control 1; however, the light intensities thereof (about 657 to 1206 mcd/m²) are substantially higher than that of control 1. In addition, the light intensities of examples A4 (about 1181 mcd/m²) and A6 (about 1206 mcd/m²) are even higher than that of the pure phosphorescent material (Control 3), which is about 1177 mcd/m².

Continuing with Table 2, example A7 comprises about 5% of the phosphorescent material and has a light intensity of about 515 mcd/m². When the concentration of the phosphorescent material in the total composition is further increased to about 10 wt % (example A8), the light intensity of the phosphorescent masterbatch is about 829 mcd/m², which is substantially higher than that of control 1.

Moreover, when the concentration of the phosphorescent material in the total composition is further increased to about 20 wt % (example A10), the light intensity of the phosphorescent masterbatch is about 1290 mcd/m², which is substantially higher than that of pure phosphorescent material (control 3).

Examples series B differ from examples series A in that the crosslinking agent used therein is triallyl-ammoniumcyanurate rather than TAC. From the results shown in Table 2, it is established that the phosphorescent masterbatches of examples B1 to B4 also exhibit better afterglow characteristics than the conventional (non-crosslinked) masterbatch.

Examples series C employ polyamide as the thermoplastic material of the masterbatch. As can be seen in Table 2, the conventional phosphorescent masterbatch of control 2 comprises about 15 wt % of the phosphorescent material, and the light intensity of the afterglow thereof is about 156 mcd/m². The phosphorescent masterbatches of examples C1 to C4, on the other hand, exhibit improved afterglow characteristics than the conventional one. Specifically, example C3 comprises only about 3 wt % of the phosphorescent material, yet has a light intensity of the afterglow of about 257 mcd/m², which is substantially higher than that of control 2.

Furthermore, when the amount of the phosphorescent material is increased to about 7 wt % as in example C1, the light intensity of the afterglow thereof is further improved to about 657 mcd/m², which is more than four times of that of control 2.

Although the inventors do not want to bind this invention with any particular scientific theory, it is speculated that the improved light intensity may be partially resulted from the molecular structure of the cross-linked thermoplastic polymer. For one reason, the cross-linked polymer may have a less rigid polymer chain structure than the conventional (non-crosslinked) polymer, and hence, during the compounding steps, the phosphorescent material may be better dispersed across the cross-linked polymer as comparing with the conventional polymers.

In addition, the crosslinking agent may also alter the networking among the polymer chains of the cross-linked polymer so that the light from the external source may pass through the polymer chains more easily. As such, the light may not only illuminate the phosphorescent materials in adjacent to the surface of the cross-linked polymer but also the phosphorescent materials thereunder. As a result, the amount of the phosphorescent materials that are energized by the external light source is more than that of the conventional polymer, and the light intensity of the afterglow of the phosphorescent masterbatch would increase accordingly.

Further, the light emitted by some phosphorescent materials may in turn energize other phosphorescent materials so as to increase the overall light intensity of the phosphorescent masterbatch.

The afterglow time of some examples was also measured. The sample was illuminated by CIE (International Commission on Illumination) standard illuminant D65 for about 20 minutes. Afterwards, the sample was put in a dark room to allow the sample to glow until the light intensity of the sample is decreased to reach about 0.32 mcd/m², and the time elapsed was recorded as the afterglow time of the sample.

The range of afterglow times of examples A1 to A6 and B1 to B4 is about 2788 to 3416 minutes, while the afterglow times of Controls 1 is about 1964 minutes.

### (III) Application of Phosphorescent Masterbatches

The phosphorescent masterbatch of the present invention may be used to manufacture a wide range of luminescent articles.

According to various embodiments of the present invention, the luminescent article comprises a luminescent portion that is at least made of the phosphorescent masterbatch according to the above-mentioned embodiments of the present invention.

Specifically, the luminescent portion may be made in a form of a fiber, a filament, a yarn, a textile, a film, a sheet, or a chip. The form (or the shape) of the luminescent article may be the same as or different from the form of the luminescent portion.

In some applications according to embodiments of the present invention, the phosphorescent masterbatch alone may be used to manufacture the luminescent portion and/or the luminescent article. In some other applications according to embodiments of the present invention, at least one processing thermoplastic polymer, should be used in conjunction with the phosphorescent masterbatch in order to manufacture the luminescent portion and/or the luminescent article. In the latter case, the weight ratio of the phosphorescent masterbatch to the processing thermoplastic polymer is determined depending on the composition of the phosphorescent masterbatch and the intended property of the resultant product. Generally, the weight ratio of the phosphorescent masterbatch to the processing thermoplastic polymer is about 1:1 to 1:10.

Depending on the design of the luminescent article the thermoplastic polymer of the phosphorescent masterbatch may be the same as or different from the processing thermoplastic polymer. The example of the processing thermoplastic polymer includes, but is not limited to, polyester, PP, or polyamide.

For example, the luminescent article may be a core-sheath conjugate fiber, wherein the luminescent portion is the core or the sheath. According to one embodiment, about 50 wt % of the phosphorescent masterbatch of example A10 and about 50 wt % of PBT polymer (as the processing thermoplastic polymer) were used to prepare a core-sheath conjugate fiber by melt-spinning. The tensile strength of this conjugate fiber is about 1.74 g/den.

In some alternative applications, the luminescent article may be a textile having a luminescent thin film formed thereon. In some other alternative applications, the luminescent article is an injection-molded article made substantially from the phosphorescent masterbatch. Many other luminescent articles are possible and has been envisaged by the inventors, and thus, are within the scope of the invention as defined by the appended claims.

It will be understood that the above description of embodiments are given by way of example only and that various modifications may be made by those with ordinary skill in the art. The above specification, examples and data provide a complete description of the structure and use of exemplary embodiments of the invention. Although various embodiments of the invention have been described above with a certain degree of particularity, or with reference to one or more individual embodiments, those with ordinary skill in the art could make numerous alterations to the disclosed embodiments without departing from the spirit or scope of this invention.

1. A composition for preparing a phosphorescent masterbatch, comprising:
a phosphorescent material in an amount of about 3.0 to 45.0 percent by weight;
a crosslinking agent in an amount of about 0.1 to 10.0 percent by weight;
a thermoplastic polymer in an amount of about 38.0 to 96.8 percent by weight;
a crosslinking initiator in an amount of about 0 to 2.0 percent by weight; and
a dispersing agent in an amount of about 0.1 to 5.0 percent by weight.

2. The composition of claim 1, wherein the phosphorescent material is a rare-earth-doped aluminate.

3. The composition of claim 2, wherein the rare-earth-doped aluminate has a formula of (MAl₂O₄:Eu,Re), where M is Mg, Ca, Sr, or Ba, and Re is Y, La, Ce, Pr, Nd, Sm, Gd, Tb, Dy, Ho, Er, Tm, Yb or Lu.

4. The composition of claim 1, wherein the phosphorescent material is a metal sulfide.

5. The composition of claim 4, wherein the metal sulfide is zinc sulfide, cadmium sulfide, calcium sulfide, or strontium sulfide.

6. The composition of claim 1, wherein the crosslinking agent is triacryloylhexahydro-1,3,5-triazine.

7. The composition of claim 1, wherein the crosslinking agent is a diallyl compound or a triallyl compound.

8. The composition of claim 7, wherein the diallyl compound is diallyl phthalate, diallyl succinate, or N,N′-diallyltartramide.

9. The composition of claim 7, wherein the triallyl compound is triallylamine, triallyl trimesate, triallyl cyanurate, triallyl isocyanurate, or triallyl-ammoniumcyanurate.

10. The composition of claim 1, wherein the crosslinking initiator is potassium persulfate, azobisisobutyronitrile, or benzyl dimethyl ketal.

11. The composition of claim 1, wherein the dispersing agent is selected from a group consisting of C₁₅₋₃₈ alkanes, C₁₅₋₃₈ esters, C₁₅₋₃₈ organic acids, and a mixture thereof.

12. The composition of claim 1, wherein the thermoplastic polymer is polyester.

13. The composition of claim 12, wherein the polyester is polyethylene terephthalate, polybutylene terephthalate, or polytrimethylene terephthalate.

14. The composition of claim 12, wherein the phosphorescent material is in an amount of about 10 to 15 percent by weight.

15. The composition of claim 12, wherein the crosslinking agent is in an amount of about 0.1 to 5 percent by weight.

16. The composition of claim 1, wherein:
the phosphorescent material is about 10 to 15 percent by weight of SrAl₂O₄:Eu,Dy;
the crosslinking agent is about 0.5 to 2 percent by weight of triallyl-ammoniumcyanurate;
the thermoplastic polymer is about 81.3 to 88.9 percent by weight of polybutylene terephthalate;
the crosslinking initiator is about 0.1 to 0.2 percent by weight of benzyl dimethyl ketal; and
the dispersing agent is about 0.5 to 1.5 percent by weight of a mixture of C₁₅₋₃₈ alkanes, C₁₅₋₃₈ esters, and C₁₅₋₃₈ organic acids.

17. The composition of claim 1, wherein:
the thermoplastic polymer is polyamide in an amount of about 74.0 to 96.8 percent by weight;
the phosphorescent material is in an amount of about 3.0 to 15.0 percent by weight;
the crosslinking agent is in an amount of about 0.1 to 5.0 percent by weight; and
the crosslinking initiator is in an amount of about 0 to 1.0 percent by weight.

18. The composition of claim 17, wherein:
the phosphorescent material is SrAl₂O₄:Eu,Dy;
the crosslinking agent is triallyl-ammoniumcyanurate; and
the crosslinking initiator is benzyl dimethyl ketal.

19. A process for preparing a phosphorescent masterbatch, comprising the steps of:
compounding the composition of claim 1 to melt the thermoplastic polymer whereby the melted thermoplastic polymer is cross-linked by the crosslinking agent, and the phosphorescent material is dispersed in the cross-linked thermoplastic polymer; and
pelletizing the cross-linked thermoplastic polymer having the phosphorescent material dispersed therein to obtain the phosphorescent masterbatch.

20. The process of claim 19, wherein the phosphorescent material is a rare-earth-doped aluminate having a formula of (MAl₂O₄:Eu,Re), where M is Mg, Ca, Sr, or Ba, and Re is Y, La, Ce, Pr, Nd, Sm, Gd, Tb, Dy, Ho, Er, Tm, Yb or Lu.

21. The process of claim 19, wherein the phosphorescent material is zinc sulfide, cadmium sulfide, calcium sulfide, or strontium sulfide.

22. The process of claim 19, wherein the crosslinking agent is triacryloylhexahydro-1,3,5-triazine, diallyl phthalate, diallyl succinate, N,N′-diallyltartramide, triallylamine, triallyl trimesate, triallyl cyanurate, triallyl isocyanurate, or triallyl-ammoniumcyanurate.

23. The process of claim 19, wherein the crosslinking initiator is potassium persulfate, azobisisobutyronitrile, or benzyl dimethyl ketal.

24. The process of claim 19, wherein the dispersing agent is selected from a group consisting of C₁₅₋₃₈ alkanes, C₁₅₋₃₈ esters, C₁₅₋₃₈ organic acids, and a mixture thereof.

25. The process of claim 19, wherein the thermoplastic polymer is polyester.

26. The process of claim 25, wherein the polyester is polyethylene terephthalate, polybutylene terephthalate, or polytrimethylene terephthalate.

27. The process of claim 19, wherein:
the phosphorescent material is about 10 to 15 percent by weight of SrAl₂O₄:Eu,Dy;
the crosslinking agent is about 0.5 to 2 percent by weight of triallyl-ammoniumcyanurate;
the thermoplastic polymer is about 81.3 to 88.9 percent by weight of polybutylene terephthalate;
the crosslinking initiator is about 0.1 to 0.2 percent by weight of benzyl dimethyl ketal; and
the dispersing agent is about 0.5 to 1.5 percent by weight of a mixture of C₁₅₋₃₈ alkanes, C₁₅₋₃₈ esters, and C₁₅₋₃₈ organic acids.

28. The process of claim 19, wherein:
the thermoplastic polymer is polyamide in an amount of about 74.0 to 96.8 percent by weight;
the phosphorescent material is in an amount of about 3.0 to 15.0 percent by weight;
the crosslinking agent is in an amount of about 0.1 to 5.0 percent by weight; and
the crosslinking initiator is in an amount of about 0 to 1.0 percent by weight.

29. The process of claim 28, wherein:
the phosphorescent material is SrAl₂O₄:Eu,Dy;
the crosslinking agent is triallyl-ammoniumcyanurate; and
the crosslinking initiator is benzyl dimethyl ketal.

30. A phosphorescent masterbatch prepared in accordance with a process comprising the steps of:
compounding a composition to melt the thermoplastic polymer, wherein the composition comprises:
a thermoplastic polymer in an amount of about 38.0 to 96.8 percent by weight;
a crosslinking initiator in an amount of about 0 to 2.0 percent by weight;
a crosslinking agent in an amount of about 0.1 to 10.0 percent by weight, whereby the melted thermoplastic polymer is cross-linked by the crosslinking agent;
a phosphorescent material in an amount of about 3.0 to 45.0 percent by weight; and
a dispersing agent in an amount of about 0.1 to 5.0 percent by weight, whereby the phosphorescent material is dispersed in the cross-linked thermoplastic polymer; and
pelletizing the cross-linked thermoplastic polymer having the phosphorescent material dispersed therein to obtain the phosphorescent masterbatch.

31. An article of manufacture comprising a luminescent portion, wherein the luminescent portion is at least made of the phosphorescent masterbatch of claim 30.

32. The luminescent article of claim 31, wherein the luminescent portion is in a form of a fiber, a filament, a yarn, a textile, a film, a sheet, or a chip.

33. The luminescent article of claim 31, wherein the thermoplastic polymer is polyester or polyamide.

34. The luminescent article of claim 31, further comprising a processing thermoplastic polymer.

35. The luminescent article of claim 34, wherein the weight ratio of the phosphorescent masterbatch to the processing thermoplastic polymer is about 1:1 to 1:10.

36. The luminescent article of claim 34, wherein the thermoplastic polymer is polyester, polypropylene, or polyamide.

37. The luminescent article of claim 34, wherein the thermoplastic polymer of the phosphorescent masterbatch is the same as or different from the processing thermoplastic polymer.

38. The phosphorescent masterbatch of claim 30, wherein the crosslinking agent is triallyloylhexahydro-1,3,5-triazine, diallyl phthalate, diallyl succinate, N,N′-diallyltartramide, triallylamine, triallyl trimesate, triallyl cyanurate, triallyl isocyanurate, or triallyl-ammoniumcyanurate.

39. The phosphorescent masterbatch of claim 30, wherein the crosslinking initiator is potassium persulfate, azobisisobutyronitrile, or benzyl dimethyl ketal.

40. The phosphorescent masterbatch of claim 30, wherein the phosphorescent material is a rare-earth-doped aluminate having a formula of (MAI₂O₄:Eu,Re), where M is Mg, Ca, Sr, or Ba, and Re is Y, La, Ce, Pr, Nd, Sm, Gd, Tb, Dy, Ho, Er, Tm, Yb or Lu.

41. The phosphorescent masterbatch of claim 30, wherein the phosphorescent material is a metal sulfide and the wherein the phosphorescent material is a metal sulfide.

42. The phosphorescent masterbatch of claim 30, wherein the crosslinking initiator is potassium persulfate, azobisisobutyronitrile, or benzyl dimethyl ketal.

43. The phosphorescent masterbatch of claim 30, wherein the dispersing agent is selected from a group consisting of C₁₅₋₃₈ alkanes, C₁₅₋₃₈ esters, C₁₅₋₃₈ organic acids, and a mixture thereof.

44. The phosphorescent masterbatch of claim 30, wherein the thermoplastic polymer is polyester and the wherein the thermoplastic polymer is polyester.
